(19) United States
(12) Patent Application Publication
(10) Pub. No.: US 2013/0271642 A1
(43) Pub. Date: Oct. 17, 2013

(54) IMAGE PICKUP LENS, IMAGE PICKUP APPARATUS AND PORTABLE TERMINAL

(71) Applicant: Eigo Sano, Hino-shi (JP)

(72) Inventor: Eigo Sano, Hino-shi (JP)

(21) Appl. No.: 13/880,971

(22) PCT Filed: Oct. 6, 2011
(86) PCT No.: PCT/JP2011/073060

§ 371 Date: Jul. 2, 2013

(30) Foreign Application Priority Data
Oct. 21, 2010 (JP) 2010-2364249

(51) Int. Cl. G02B 13/00

(52) U.S. Cl. CPC G02B 13/0045
USPC 348/340; 359/714

(57) ABSTRACT

Image pickup lens comprises: in order from an object side, a first lens having positive refractive power and a convex surface facing toward the object side; a meniscus-shaped second lens having negative refractive power and a convex surface facing toward the object side; a third lens having positive or negative refractive power; a fourth lens having positive refractive power and a convex surface facing toward an image side; and a fifth lens having negative refractive power and a concave surface facing toward the image side. An image-side surface of the fifth lens has an aspherical shape and inflection points at positions other than an intersection point with an optical axis, and the image pickup lens satisfies: 1.5<f12/f<3.0, where f12 is composite focal length of the first lens and the second lens, and f is focal length of an entire image pickup lens system.

### TECHNICAL FIELD

The present invention relates to an image pickup lens suitable for an image pickup apparatus employing a solid-state image sensor, such as a CCD image sensor or a CMOS image sensor.

### BACKGROUND ART

Recently, following the wide spread of a portable terminal equipped with an image pickup apparatus employing a solid-state image sensor such as a CCD image sensor or a CMOS image sensor, there has been supplied to a market the portable terminal equipped with the image pickup apparatus employing the solid-state image sensor having a great number of pixels so as to obtain a higher resolution image.

Recently, the solid-state image sensor having the great number of pixels has advanced in high definition of pixels, and its miniaturization has been promoted. An image pickup lens to be employed in such a high definition solid-state image sensor requires high resolution power. The resolution power has a limitation depending on an F value, and the conventional F value of a level of F2.8 is insufficient to obtain the high resolution, and a bright lens having a small F value is appropriate. Therefore, there has been demanded a bright lens having brightness of F2 or less, which is suitable for a compact solid-state image sensor having high definition pixels and the great number of pixels. As an image pickup lens for such use, there is proposed a five-component image pickup lens allowing large diameter ratio and high performance to be provided, as compared to a three-component or four-component lens.

As the five-component image pickup lens, there is known an image pickup lens which consists of: a former group including in order from an object side a first lens having positive or negative refractive power and a second lens having positive refractive power; and a latter group including an aperture stop, a third lens having negative refractive power, a fourth lens having positive refractive power, and a fifth lens having negative or positive refractive power (see, for example, Patent Documents 1 and 2).

Moreover, a four-component image pickup lens having brightness of about F2 is also known (see, for example, Patent Document 3)

### CITATION LIST

### Patent Documents

Patent Document 1: Japanese Patent Application Publication No. 2007-279282
Patent Document 2: Japanese Patent Application Publication No. 2006-293042
Patent Document 3: Japanese Patent Application Publication No. 2007-322844

### SUMMARY OF INVENTION

### Problem to be Solved by Invention

However, in the image pickup lens described in the above Patent Document 1, since the former group consists of a spherical system, if the brightness is set to a level of F2, it is impossible to ensure preferable performance because a spherical aberration or comatic aberration is not sufficiently corrected. Moreover, both the former group and the latter group are configured so as to have positive refractive power, therefore, this structure is a type disadvantageous to miniaturization because a principal point in the optical system is shifted to the image side, which results in having a long back focus, as compared to a structure such as a telephoto type having in which the latter group has a negative refractive power.

Moreover, the image pickup lens described in the above Patent Document 2 has brightness of a level of F2, but both the first lens and the second lens have positive refractive power, therefore, a chromatic correction in the former group is insufficient. Furthermore, in this image pickup lens, both the former group and the latter group are configured so as to have positive refractive power, like the above Patent Document 1, and the final lens is also a positive lens, therefore, this image pickup lens is a type disadvantageous to miniaturization.

Furthermore, the image pickup lens described in the above Patent Document 3, which has brightness of a level of F2, is insufficient to correct aberrations because of a four-component type. Therefore, it is improbable that this structure is suitable for the image pickup lens meeting high definition pixels.

In light of the aforementioned problems, it is an objective of the present invention to provide a five-component image pickup lens that is small in size and has sufficient brightness of F2 or less and in which aberrations have been favorably corrected, as well as an image pickup apparatus having the image pickup lens and a portable terminal having the image pickup apparatus.

In addition, regarding a measure of a compact image pickup lens, the present invention aims for miniaturization in a level satisfying the following formula. It is possible to reduce in size and weight the whole image pickup apparatus by satisfying this range.

L/2Y<1.1 (6)

where

L: distance along an optical axis from a lens surface closest to an object to an image-side focus in an entire image pickup lens system; and

2Y: diagonal line length of an imaging plane of a solid-state image sensor (diagonal line length of a rectangular effective pixel region of a solid-state image sensor).

Herein, the image-side focus is an image point in the case where a parallel light beam parallel to an optical axis enters to an image pickup lens.

In addition, in the case where an optical low-pass filter, an infrared rays cut-filter, or a parallel plate element such as a glass sheet of a solid-state image sensor package are arranged between a surface closest to the image side and the image-side focus of the image pickup lens, the above value of L is assumed to be calculated after setting a portion of the parallel plate element at an air equivalent distance.

### Solution to Problem

The aforementioned objective is attained by an under-mentioned structure.

An image pickup lens as recited in claim 1 is for forming an image of a subject on a photoelectric converting portion of a solid-state image sensor, and the image pickup lens comprises: in order from an object side, a first lens having positive refractive power and having a convex surface facing toward the object side; a meniscus-shaped second lens having negative refractive power and having a convex surface facing toward the object side; a third lens having positive or negative refractive power; a fourth lens having positive refractive power and having a convex surface facing toward an image side; and a fifth lens having negative refractive power and having a concave surface facing toward the image side, wherein an image-side surface of the fifth lens has an aspherical shape and has inflection points at positions other than an intersection point with an optical axis, and

the image pickup lens satisfies the following conditional formula:

1.5<f12/f<3.0 (1)

where

f12: composite focal length of the first lens and the second lens; and

f: focal length of an entire image pickup lens system.

The basic structure of the present invention for obtaining an image pickup lens that is small in size and in which aberrations are favorably corrected, includes: a first lens having positive refractive power and having a convex surface facing toward an object side; a meniscus-shaped second lens having negative refractive power and having a convex surface facing toward the object side; a third lens having positive or negative refractive power; a fourth lens having positive refractive power and having a convex surface facing toward the image side; and a fifth lens having negative refractive power and having a concave surface facing toward the image side.

Such lens structure as so-called telephoto type, in which a group of positive lenses comprising in order from an object side, a first lens, a second lens, a third lens and a fourth lens, and a negative fifth lens are arranged, is a structure advantageous to reduce in size the total length of an image pickup lens.

Furthermore, the inclusion of two or three negative lenses in the five-component lens makes it possible to easily correct a Petzval sum by increasing the number of surfaces having a dispersion effect and to obtain an image pickup lens ensuring preferable focusing performance up to an image periphery. Furthermore, by making the second lens have a meniscus shape, it is possible to arrange a composite principal point position of the entire image pickup lens system closer to the object side and to cause the image-side surface of the second lens to become a strong dispersion surface, thereby making it easy to correct comatic aberration or distortion.

Moreover, by causing the image-side surface of the fifth lens arranged closest to the image side to have an aspherical shape, it is possible to preferably correct aberrations at a screen periphery. Furthermore, the use of aspherical shape having inflection points at positions other than an intersection point with an optical axis makes it easy to ensure a telecentric characteristic of an image-side light beam.

Herein, the “inflection point” means a point on an aspherical surface so that a tangent plane of an aspherical top becomes a flat plane perpendicular to an optical axis, in a curve of a lens cross-sectional shape within an effective radius.

The conditional formula (1) is for that the composite focal length of the first lens and the second lens is appropriately adjusted to thereby attain both the suppression of a high order of spherical aberration or comatic aberration making problematic in a large diameter lens and the reduction of the total length of the image pickup lens.

In a large diameter optical system, since a very thick light beam enters to the first lens or the second lens near a diaphragm, if the refractive power of the first lens or the second lens is unnecessarily strong, the generation of the high order of spherical aberration and the variation of an image surface due to manufacturing error are caused. Therefore, exceeding the lower limit in the above conditional formula makes it possible to prevent the positive composite focal of the first lens and the second lens from becoming too small unnecessarily and to reduce the high order of spherical aberration or comatic aberration generated in the first lens or the second lens, and properly reducing the refractive power of each of the first lens and the second lens allows the variation of the image surface due to manufacturing errors to be decreased. On the other hand, falling below the upper limit allows the positive composite focal length of the first lens and the second lens to be properly maintained, therefore, it is possible to arrange the principal point position of the entire system closer to the object side and to shorten the total length of the image pickup lens.

Moreover, it is more preferable to satisfy the following formula:

1.7<f12/f<2.8 (1)′

An imaging pickup lens as recited in claim 2 in the invention according to claim 1 is characterized by satisfying the following conditional formula:

0.15<d5/f<0.35 (2)

where

d5: thickness along the optical axis of the third lens; and

f: focal length of the entire image pickup lens system.

The conditional formula (2) is that for appropriately adjusting the thickness on the optical axis of the third lens.

The third lens, in which positive refractive power at the image-side surface periphery is stronger than that at the image-side center to smoothly guide the periphery light beam splashed by the second lens to a succeeding lens system, has a shape largely leaning to the object side at its image-side periphery. Thus, a flange thickness outside the effective diameter of the third lens is apt to become thin, causing a molding property to deteriorate.

Therefore, exceeding the lower limit in the above conditional formula allows the thickness on the optical axis of the third lens to be properly maintained, and even if the positive refractive power at the image-side periphery of the third lens is strengthened, it is easy to ensure the flange thickness on the outside of an effective diameter. On the other hand, falling below the upper limit allows preventing the thickness on the optical axis of the third lens from becoming too large, thereby making it possible to properly maintain a clearance between the third lens and its front and back lenses to shorten the total length of the image pickup lens.

Moreover, it is more preferable to satisfy the following formula:

0.15<d5/f<0.30 (2)′

An image pickup lens as recited in claim 3 in the invention according to claim 1 or 2 is characterized by satisfying the following conditional formula:

0<f/|f3|<0.35 (3)

where

f: focal length of the entire image pickup lens system; and

f3: focal length of the third lens.

The conditional formula (3) is that for appropriately adjusting the focal length of the third lens to attain both the reduction of the image pickup lens total length and the correction of aberrations.

Exceeding the lower limit in the conditional formula (3) allows the refractive power of the third lens to be properly maintained, so that it becomes advantageous in correction of aberrations. On the other hand, falling below the upper limit allows preventing the refractive power of the third lens from becoming too strong, thereby making it possible to shorten the image pickup lens total length.

Moreover, it is more preferable to satisfy the following formula:

0<f/|f3|<0.30 (3)′

An image pickup lens as recited in claim 4 in the invention according to any one of claims 1 to 3 is characterized by satisfying the following conditional formula:

0.50<f34/f<0.95 (4)

where

f34: composite focal length of the third lens and the fourth lens; and

f: focal length of the entire image pickup lens system.

The conditional formula (4) is that for appropriately adjusting the composite focal length of the third lens and the fourth lens.

Exceeding the lower limit in the conditional formula (4) allows preventing the composite refractive power of the third lens and the fourth lens from becoming too strong, so that the principal position of the entire image pickup lens system can be arranged closer to the object side, and hence it is possible to shorten the total length of the image pickup lens. Moreover, it is possible to reduce comatic aberration or field curvature generated in the fourth lens. On the other hand, falling below the upper limit makes it possible to properly maintain the composite refractive power of the third lens and the fourth lens, so that the periphery light beam splashed by the second lens is smoothly guided to the fifth lens, and hence it is easy to ensure an image-side telecentric characteristic.

Moreover, it is more preferable to satisfy the following formula:

0.55<f34/f<0.90 (4)′

An image pickup lens as recited in claim 5 in the invention according to any one of claims 1 to 4 is characterized in that the fourth lens has a biconvex shape.

Making the fourth lens have the biconvex shape allows the refractive power of the fourth lens to be strengthened, and strongly refracting a light beam near the optical axis provides a structure advantageous to a large diameter.

An image pickup lens as recited in claim 6 in the invention according to any one of claims 1 to 5 is characterized by satisfying the following conditional formula:

15<ν5<50 (5)

where
ν5: Abbe number of the fifth lens.

The conditional formula (5) is that for appropriately adjusting an Abbe number of the fifth lens.

Using material satisfying the range defined by the conditional formula (5) makes it possible to appropriately maintain balance between longitudinal chromatic aberration and magnification chromatic aberration.

Moreover, it is more preferable to satisfy the following formula:

15<ν2<31 (5)

Moreover, it is further preferable to satisfy the following formula:

15<ν2<21 (5)″

An image pickup lens as recited in claim 7 in the invention according to any one of claims 1 to 6 is characterized in that an aperture stop is arranged at a position toward the image side from a position on the optical axis of an object-side surface of the first lens and toward the object side from an outermost periphery of the object-side surface of the first lens.

Arranging the aperture stop at the position toward the image side from the position on the optical axis of the object-side surface of the first lens and toward the object side from the outermost periphery of the object-side surface of the first lens makes it possible to reduce a refractive angle on the object-side surface of the first lens, therefore, it is possible to reduce the high order of spherical aberration or comatic aberration generated in the first lens. Moreover, since the height of a light beam passing through the first lens can be reduced, it is possible to easily ensure an edge thickness of the first lens to improve a molding property. Particularly, this is an important requirement in a large diameter optical system.

An image pickup lens as recited in claim 8 in the invention according to any one of claims 1 to 7 is characterized in that focusing operation is performed by fixing the first lens, the second lens and the fifth lens of the image pickup lens with respect to an imaging plane, and moving the third lens and the fourth lens are moved together in a direction of the optical axis.

Fixing the first lens, the second lens and the fifth lens and driving only the third lens and fourth lens make it possible to perform focusing without causing spherical aberration or chromatic aberration, field curvature and the like to deteriorate. Moreover, focusing movement amount and focus driving force can be reduced as compared to so-called whole sending-out process where the entire image pickup lens system is sent out in a body, therefore, it is possible to achieve conservation of electric power and miniaturization of an actuator, and since the total length of the image pickup lens becomes invariable, the optical unit can become super compact. Furthermore, dust can be prevented from getting into image pickup lens units, and it is also possible to achieve the cost reduction by abolishing steps and the reduction of an environmental load by cutting defects.

An image pickup lens as recited in claim 9 in the invention according to any one of claims 1 to 8 is characterized in that all the third lens, the fourth lens and the fifth lens of the image pickup lens have an inflection point at positions other than the intersection point with the optical axis of at least one side surface.

All the third lens, the fourth lens and the fifth lens of the image pickup lens have an inflection point at positions other than the intersection point with the optical axis of at least one side surface, whereby it is possible to change the refractive power of the lenses from the third lens to the fifty lens which are important to correct abaxial aberration, near a center and at a periphery, and this makes it easy to correct field curvature or distortion of a light beam passing through near the inflection points, thereby allowing design freedom to be improved.

An image pickup lens as recited in claim 10 in the invention according to any one of claims 1 to 9 is characterized in that all the first lens, the second lens, the third lens, the fourth lens, and the fifth lens are formed from a plastic material.

Recently, for miniaturizing the whole image pickup apparatus, there has been developed a solid-state image sensor having a small pixel pitch resulting in a small imaging plane size, even if the sensor has the same number of pixels. In the image pickup lens directed to such solid-state image sensor having the small imaging plane size, the radius of curvature or outer diameter of each lens becomes considerably small because it is necessary to make comparatively short the focal length of an entire optical system. Accordingly, it is possible to massively product in low cost the lens even if it has a small radius of curvature or outer diameter, by composing all lenses using a plastic lens manufactured by an injection molding process, as compared to a glass lens to be manufactured by time-consuming polish processing. Moreover, since the press temperature of the plastic lens can be set low, the wear of a metal mold for molding can be reduced, which results in decreasing the number of times of replacing the metal mold for molding or maintaining the metal mold, thereby allowing the cost to be reduced.

An image pickup apparatus as recited in claim 11 is characterized by having the image pickup lens as recited in any one of claims 1 to 10 and a solid-state image sensor arranged on an image side of said image pickup lens.

This makes it possible to provide an image pickup apparatus that is small in size and has sufficient brightness of F2 or less and in which aberrations have been favorably corrected.

An image pickup apparatus as recited in claim 12 in the invention according to claim 11 is characterized in that the image pickup apparatus has an adjustable diaphragm between a position on the optical axis of the object-side surface of the first lens of the image pickup lens and a position of the intersection point with the optical axis of an outermost ray of a light beam which enters to the first lens and focuses at the highest position in an image height.

Since a shutter speed becomes fast inevitably when taking a picture in a large aperture optical system of F2 or less, a flicker is apt to be generated in the image upon taking the picture under a light source having a specific frequency, such as a fluorescent lamp. Therefore, the adjustable diaphragm is arranged between a position on the optical axis of the object-side surface of the first lens of the image pickup lens, and a position of the intersection point with the optical axis of an outermost ray of a light beam which enters to the first lens and focuses at the highest position in an image height, and when the adjustable diaphragm is stopped down, the charge accumulation time of the solid-state image sensor is increased, thereby allowing the flicker to be reduced. Moreover, under sufficient bright photograph environment, it is possible to ensure preferable optical performance by stopping down the diaphragm in view of the optical performance.

A portable terminal as recited in claim 13 is characterized by having the image pickup apparatus as recited in claim 11 or 12.

This makes it possible to provide the portable terminal equipped with the image pickup apparatus having the image pickup lens that is small in size and has sufficient brightness of F2 or less and in which aberrations have been favorably corrected.

### Advantageous Effects of Invention

According to the present invention, it is possible to provide a five-component image pickup lens that is small in size and has sufficient brightness of F2 or less and in which aberrations have been favorably corrected, as well as an image pickup apparatus having the image pickup lens and a portable terminal having the image pickup apparatus.

### BRIEF DESCRIPTION OF DRAWINGS

FIG. 1 is an external appearance perspective diagram of an image pickup apparatus equipped with an image pickup lens according the present embodiment;

FIG. 2 is a diagram representing a cross section of an image pickup apparatus according the present embodiment;

FIG. 3 is an external appearance diagram of a mobile telephone as one example of a portable terminal equipped with an image pickup apparatus according to the present embodiment, and includes view (a) in which a folded mobile telephone has been unfolded and seen from inside, and view (b) in which the folded mobile telephone has unfolded and seen from outside;

FIG. 4 is a diagram representing one example of a control block of a mobile telephone;

FIG. 5 is a cross-sectional diagram of an image pickup lens of Example 1;

FIG. 6 is an aberration chart of an image pickup lens of Example 1 (spherical aberration, astigmatism, distortion, and meridional comatic aberration);

FIG. 7 is a cross-sectional diagram of an image pickup lens of Example 2;

FIG. 8 is an aberration chart of an image pickup lens of Example 2 (spherical aberration, astigmatism, distortion, and meridional comatic aberration);

FIG. 9 is a cross-sectional diagram of an image pickup lens of Example 3;

FIG. 10 is an aberration chart of an image pickup lens of Example 3 (spherical aberration, astigmatism, distortion, and meridional comatic aberration);

FIG. 11 is a cross-sectional diagram of an image pickup lens of Example 4; and

FIG. 12 is an aberration chart of an image pickup lens of Example 4 (spherical aberration, astigmatism, distortion, and meridional comatic aberration).

### DESCRIPTION OF EMBODIMENTS

The present invention is explained in detail on the basis of an embodiment, hereinafter. However, the present invention is not limited to the embodiment.

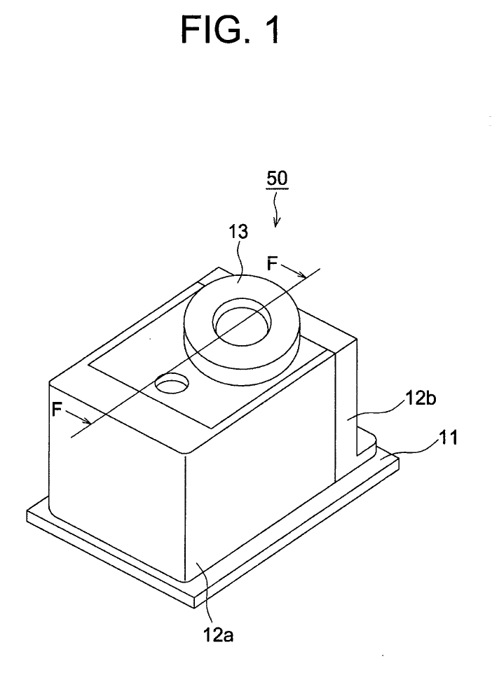

FIG. 1 is an external appearance perspective diagram of an image pickup apparatus 50 equipped with an image pickup lens according the present embodiment.

As shown in FIG. 1, the image pickup apparatus 50 has a printed board 11 on which a solid-state image sensor is mounted, cover members 12a and 12b, and an adjustable diaphragm apparatus 13. Moreover, a connection unit for connecting the image pickup apparatus 50 to another board of a portable terminal is formed on a back side of the printed board 11.

The inside of the image pickup apparatus 50 is explained, hereinafter.

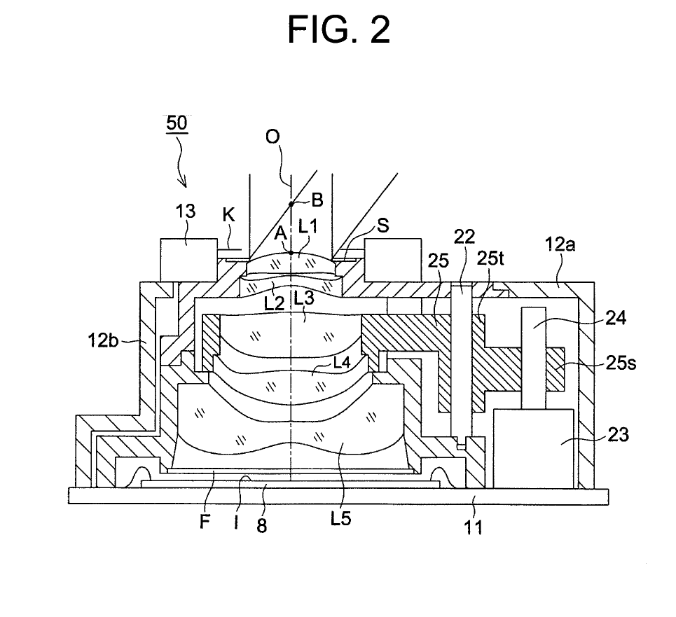

FIG. 2 is a diagram representing a cross section of the image pickup apparatus 50 according the present embodiment. This figure is a representation of a cross section taken along an F-F line shown in FIG. 1 for the image pickup apparatus 50.

In FIG. 2, O is an optical axis, S is an aperture stop for regulating an aperture, L1 is a first lens, L2 is a second lens, L3 is a third lens, L4 is a fourth lens, and L5 is a fifth lens. The first lens L1 has positive refractive power and has a convex surface facing toward an object side. The second lens L2 has negative refractive power and has a meniscus shape having a convex surface facing toward the object side. The fourth lens L4 has positive refractive power and has a convex surface facing toward an image side. The fifth lens L5 has negative refractive power and has a concave surface facing toward the image side.

F is a parallel plate element such as an optical low-pass filter or IR cut filter, 8 is a solid-state image sensor which is mounted on the printed board 11. Moreover, I is an imaging plane of the solid-state image sensor 8. 22 is a first guide axis, 23 is a piezoelectric device, and 24 is a second guide axis which is fixed to an edge surface of the piezoelectric device 23. The first guide axis 22 and second guide axis 24 are arranged in substantially parallel to the optical axis O.

The aperture stop S is arranged at a position which exists toward the image side from a position on the optical axis O of an object-side surface of the first lens L1, as shown by an indication A and toward the object side from an outermost periphery of the object-side surface of the first lens L1. Moreover, there is arranged an adjustable diaphragm K to be driven by an adjustable diaphragm apparatus 13 between a position on the optical axis of the object-side surface of the first lens, as shown by the indication A and the intersection point with the optical axis of an outermost ray of a light beam which enters to the first lens and focuses at the highest position in an image height, as shown by an indication B.

Moreover, the first lens L1, the second lens L2 and the fifth lens L5 are fixed to the imaging plane I, and the third lens L3 and the fourth lens L4 are held in a movement mirror frame 25. The movement mirror frame 25 is formed in a body with a slider part 25s which is configured so as to generate a constant frictional force on the contact surface of the slider part with a guide cylinder part 25t fitting to the first guide axis 22 and second guide axis 24.

The piezoelectric device 23 is composed of laminated piezoelectric ceramics and the like and functions as an electric-powered actuator that expands and contracts in a direction of the optical axis O in response to the application of an electric voltage, and the second guide axis 24 is vibrated in the direction of the optical axis O in accordance with the expansion and contraction operation of this piezoelectric device 23. This vibration moves the slider part 25s along the second guide axis 24 toward the object and toward the solid-state image sensor 8. Thus, the third lens L3 and the fourth lens L4, which are guided by the first guide axis 22 so as to be movable in the direction of the optical axis O, can adjust their focuses in correspondence to a subject distance.

In addition, in this example, the image pickup apparatus 50 equipped with the adjustable diaphragm apparatus 13 has been explained, but it does not matter if the adjustable diaphragm apparatus 13 is not used. Moreover, while it is possible to adjust the focus in correspondence to the subject distance without changing the total length of the image pickup lens by configuring to move the third lens L3 and the fourth lens L4, the focus adjustment corresponding to the subject distance may be performed by moving the entire image pickup lens system. Moreover, the use of the piezoelectric device 23 as the actuator for focus adjustment has been explained, but the present invention is not limited to such use, and it is also possible to use as the actuator a voice coil motor or a shape memory alloy.

Furthermore, it is preferable to arrange a fixed diaphragm (not shown) for cutting unnecessary light between the lenses L1 to L5 or between the fifth lens L5 and the parallel palate element F. It is possible to prevent ghosts or flares from occurring, by arranging a rectangular fixed diaphragm on the outside of a light ray path.

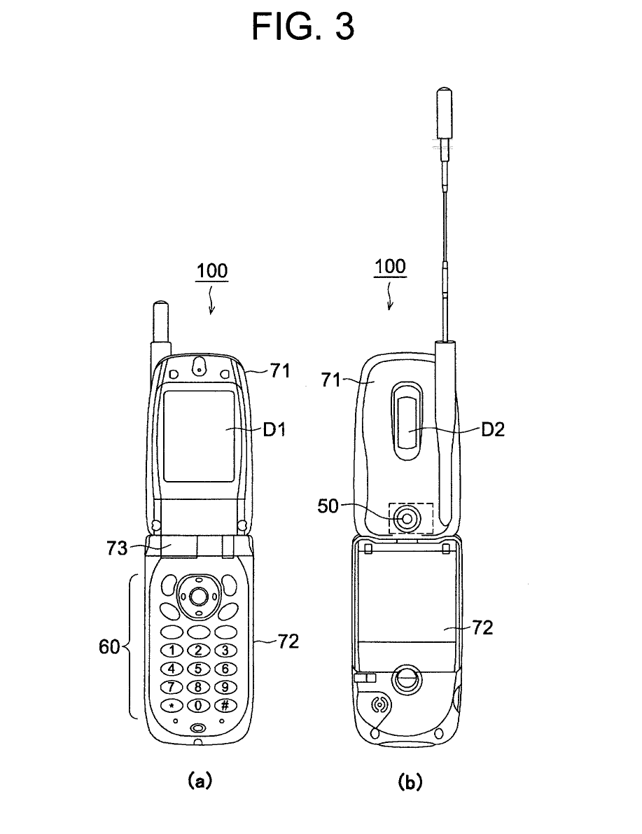

FIG. 3 is an external appearance diagram of a mobile telephone 100 as one example of a portable terminal 50 equipped with an image pickup apparatus according to the present embodiment, and includes view (a) in which a folded mobile telephone has been unfolded and seen from inside, and view (b) in which the folded mobile telephone has unfolded and seen from outside.

In the mobile telephone 100 shown in FIG. 3, there are connected via a hinge 73 an upper enclosure 71 as a case equipped with display units D1 and D2, and a lower enclosure 72 equipped with operational buttons 60 as an input unit. The image pickup apparatus 50, which is contained on a lower side of the display unit D2 within the upper enclosure 71, is arranged so that light can be imported from an outer surface side of the upper enclosure 71.

In addition, this image pickup apparatus may be located on an upside or side surface of the display unit D2 within the upper enclosure 71. Moreover, of course, the mobile telephone is not limited to a folded type.

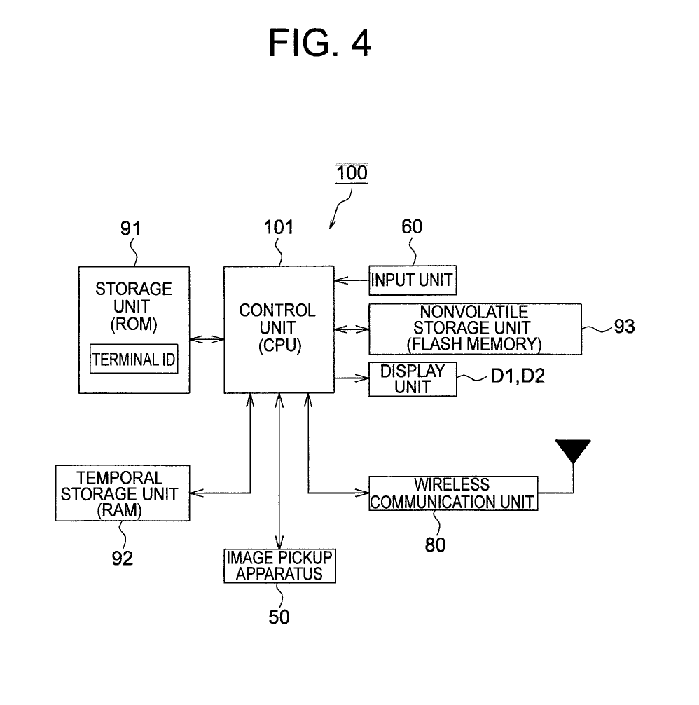

FIG. 4 is a diagram representing one example of a control block of the mobile telephone 100.

As shown in FIG. 4, the image pickup apparatus 50 is connected to a control unit 101 of the mobile telephone 100 via the printed board (not shown) to output an image signal such as a brightness signal or a chromatic difference signal to the control unit 101.

On the other hand, the mobile telephone 100 comprises: the control unit (CPU) 101 that controls each of units in an integrated manner and executes program according to each of processes; the operational buttons 60 as the input unit for indicating and inputting numbers and the like; the display units D1 and D2 for displaying predetermined data or captured image; a wireless communication unit 80 for achieving various information communication with an external server; a storage unit (ROM) 91 for storing a system program or various processing programs of the mobile telephone 100 and necessary data such as a terminal ID; and a temporal storage unit (RAM) 92 which temporarily stores the various processing programs or data, or processed data to be executed by the control unit 101 and image data by the image pickup apparatus 50 and the like, or which is used as a working region.

Moreover, an image signal inputted from the image pickup apparatus 50 is stored in a nonvolatile storage unit (a flash memory) 93, or is displayed on the display units D1, D2, or is further transmitted as image information via the wireless communication unit 80 to the outside, by the control unit 101 of the mobile telephone 100. In addition, the mobile telephone 100 has a microphone, loudspeaker (not shown) and the like for inputting and outputting sound.

Examples according to the present embodiment are presented, hereinafter.

### EXAMPLES

Symbols to be used for individual Examples are as follows.

f: focal length of an entire image pickup lens system

fB: back focus

F: F number

2Y: length of the diagonal of the imaging plane of a solid-state image sensor

ENTP: entrance pupil position (a distance from a first surface to an entrance pupil position)

EXTP: exit pupil position (a distance from an imaging plane to an exit pupil position)

H1: front-side principal position (a distance from a first surface to a front-side principal position)

H2: back-side principal position (a distance from a final surface to a back-side principal position)

R: radius of curvature

D: on-axis surface distance

Nd: index of refraction with respect to a d-line of lens material

νd: Abbe number of lens material

Moreover, in individual Examples, each surface identified by an “*” immediately following a surface number is a surface having an aspherical shape which is expressed by “Equation 1” shown below, in which a peak point of the surface corresponds to an origin, an X-axis represents a direction of the optical axis, and h represents the height measured in a direction perpendicular to the optical axis.

$$X = \frac{{h}^{2} / R}{1 + \sqrt{1 - ( 1 + K ) {h}^{2} / {R}^{2}}} + \sum {A}_{i} {h}^{i} \qquad [ Equation 1 ]$$

Where
Ai: i-th order aspherical coefficient;
R: radius of curvature; and
K: conic constant.

In addition, in under-mentioned Examples, a power of 10 (for example, 2.5×10⁻²) is expressed by using E (for example, 2.5E-02).

### Example 1

A total specification of an image pickup lens of

Example 1 is as follows

f=4.72 mm

fB=0.22 mm

F=1.80

2Y=7.178 mm

ENTP=0.00 mm

EXTP=−3.61 mm

H1=−1.10 mm

H2=−4.50 mm

Surface data of the image pickup lens of Example 1 is shown below.

| | | | | | Effective Radius |
|---|---|---|---|---|---|
| Surface No. | R (mm) | D (mm) | Nd | ν | (mm) |
| 1 (Stop) | ∞ | −0.225 | | | 1.31 |
| 2* | 3.820 | 0.633 | 1.54470 | 56.2 | 1.34 |
| 3* | −11.027 | 0.067 | | | 1.37 |
| 4* | 2.561 | 0.300 | 1.63440 | 24.0 | 1.42 |
| 5* | 1.593 | Variable Distance A | | | 1.58 |
| 6* | 8.742 | 1.393 | 1.54470 | 56.2 | 1.93 |
| 7* | 324.020 | 0.387 | | | 2.17 |
| 8* | 6.715 | 1.043 | 1.54470 | 56.2 | 2.21 |
| 9* | −2.764 | Variable Distance B | | | 2.37 |
| 10* | 7.565 | 0.641 | 1.58300 | 30.0 | 2.51 |
| 11* | 1.489 | 0.800 | | | 3.46 |
| 12 | ∞ | 0.145 | 1.51630 | 64.1 | 3.76 |
| 13 | ∞ | | | | 3.78 |

Aspherical coefficients are as follows:

Second Surface
K = 0.14302E+01, A4 = 0.13704E−01, A6 = −0.42286E−02,
A8 = 0.30120E−02, A10 = 0.68704E−03, A12 = −0.81483E−03,
A14 = 0.29332E−03
Third Surface
K = −0.13788E+02, A4 = 0.31483E−01, A6 = −0.55302E−02,
A8 = −0.68644E−05, A10 = 0.38689E−02, A12 = −0.26708E−02,
A14 = 0.71321E−03
Fourth Surface
K = −0.94328E+01, A4 = −0.50872E−01, A6 = 0.29395E−01,
A8 = −0.16253E−01, A10 = 0.24673E−02, A12 = 0.87717E−03,
A14 = −0.43732E−03
Fifth Surface
K = −0.51931E+01, A4 = −0.24719E−01, A6 = 0.14956E−01,
A8 = −0.11187E−01, A10 = 0.51660E−02, A12 = −0.15891E−02,
A14 = 0.21438E−03
Sixth Surface
K = 0.11228E+02, A4 = −0.12102E−01, A6 = −0.21307E−03,
A8 = 0.99459E−03, A10 = −0.66507E−03, A12 = 0.15956E−03,
A14 = −0.13312E−04
Seventh Surface
K = −0.61778E+06, A4 = −0.26386E−01, A6 = −0.25343E−02,
A8 = 0.21127E−03, A10 = 0.16209E−03, A12 = −0.55332E−04,
A14 = 0.56030E−05
Eighth Surface
K = −0.77644E+01, A4 = 0.43999E−02, A6 = −0.93262E−02,
A8 = 0.13835E−02, A10 = −0.12546E−03, A12 = −0.87629E−04,
A14 = 0.15671E−04
Ninth Surface
K = −0.12272E+02, A4 = −0.18292E−01, A6 = 0.60366E−02,
A8 = −0.24996E−02, A10 = 0.36957E−03, A12 = −0.39603E−04,
A14 = 0.38835E−05
Tenth Surface
K = 0.27440E+01, A4 = −0.11002E+00, A6 = 0.15838E−01,
A8 = −0.23714E−03, A10 = −0.21175E−03, A12 = 0.34565E−04,
A14 = −0.22825E−05
Eleventh Surface
K = −0.42959E+01, A4 = −0.50988E−01, A6 = 0.12222E−01,
A8 = −0.19171E−02, A10 = 0.17636E−03, A12 = −0.84190E−05,
A14 = 0.15188E−06

Single lens data of the image pickup lens of Example 1 is shown below.

| Lens | Start Surface | Focal Length (mm) |
|---|---|---|
| 1 | 2 | 5.288 |
| 2 | 4 | −7.557 |
| 3 | 6 | 16.469 |
| 4 | 8 | 3.740 |
| 5 | 10 | −3.310 |

Variable distances A and B in the surface data of the image pickup lens of Example 1 are as follows:

| Object Distance | Variable Distance A | Variable Distance B |
|---|---|---|
| Infinite | 0.815 | 0.506 |
| 100 mm | 0.691 | 0.631 |

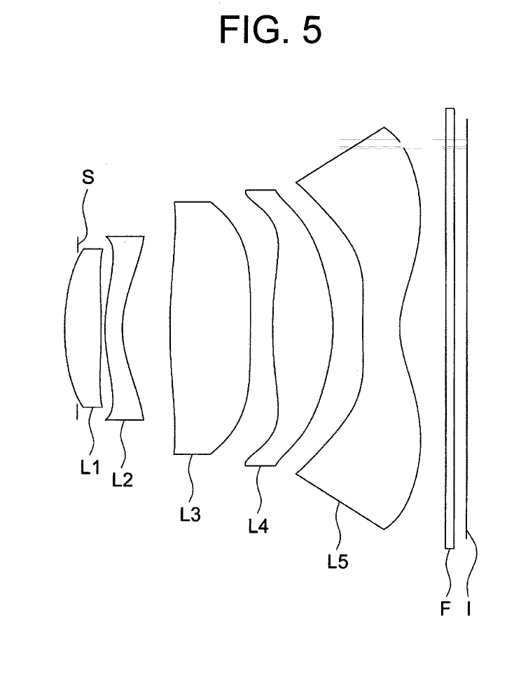

FIG. 5 is a cross-sectional diagram of an image pickup lens of Example 1. In this figure, L1 is the first lens, L2

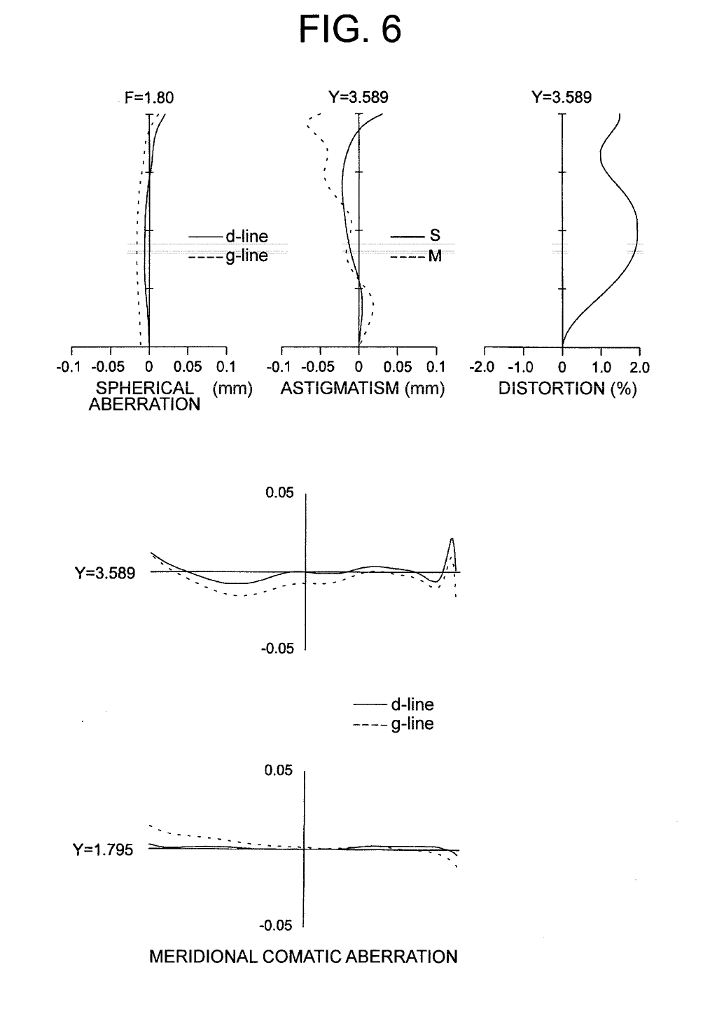

is the second lens, L3 is the third lens, L4 is the fourth lens, L5 is the fifth lens, S is the aperture stop, and I is the imaging plane. Moreover, F is the parallel plate element which may be an optical low-pass filter, an IR cut filter, seal glass of a solid-state image sensor, or the like. FIG. 6 is an aberration chart of an image pickup lens of Example 1 (spherical aberration, astigmatism, distortion, and meridional comatic aberration).

In this Example, all of lenses are formed from plastic material. The first lens, second lens and fifth lens are fixed to the imaging plane, and the third lens and fourth lens are moved in a body in the optical axis direction, thereby performing focusing operation.

### Example 2

A specification of an image pickup lens of Example 2 is as follows.

f=4.71 mm

fB=0.41 mm

F=1.80

2Y=7.178 mm

ENTP=0.00 mm

EXTP=−3.22 mm

H1=−1.40 mm

H2=−4.30 mm

Surface data of the image pickup lens of Example 2 is shown below.

| | | | | | Effective Radius |
|---|---|---|---|---|---|
| Surface No. | R (mm) | D (mm) | Nd | νd | (mm) |
| 1 (Stop) | ∞ | −0.275 | | | 1.31 |
| 2* | 2.756 | 0.695 | 1.54470 | 56.2 | 1.34 |
| 3* | −30.119 | 0.076 | | | 1.37 |
| 4* | 3.209 | 0.300 | 1.63200 | 23.4 | 1.44 |
| 5* | 1.798 | Variable Distance A | | | 1.45 |
| 6* | 5.166 | 0.802 | 1.54470 | 56.2 | 1.87 |
| 7* | 10.165 | 0.508 | | | 2.07 |
| 8* | 549.798 | 0.990 | 1.54470 | 56.2 | 2.23 |
| 9* | −2.225 | Variable Distance B | | | 2.46 |
| 10* | 3.226 | 0.629 | 1.58300 | 30.0 | 2.66 |
| 11* | 1.191 | 0.600 | | | 3.34 |
| 12 | ∞ | 0.145 | 1.51630 | 64.1 | 3.56 |
| 13 | ∞ | | | | 3.59 |

Aspherical coefficients are as follows:

Second Surface
K = 0.40284E+00, A4 = 0.37952E−02, A6 = −0.39618E−02,
A8 = 0.28149E−02, A10 = −0.25861E−04, A12 = −0.88621E−03,
A14 = 0.33596E−03
Third Surface
K = −0.50000E+02, A4 = 0.16842E−01, A6 = −0.35291E−02,
A8 = −0.37023E−04, A10 = 0.32438E−02, A12 = −0.30146E−02,
A14 = 0.91417E−03
Fourth Surface
K = −0.31672E+01, A4 = −0.56590E−01, A6 = 0.34928E−01,
A8 = −0.12540E−01, A10 = 0.10867E−02, A12 = 0.35864E−03,
A14 = 0.34402E−04
Fifth Surface
K = −0.45678E+01, A4 = −0.73141E−02, A6 = 0.18577E−01,
A8 = −0.10397E−01, A10 = 0.47195E−02, A12 = −0.16165E−02,
A14 = 0.30992E−03
Sixth Surface
K = 0.19372E+01, A4 = −0.14784E−01, A6 = −0.28229E−02,
A8 = 0.17643E−02, A10 = −0.71958E−03, A12 = 0.14129E−03,
A14 = −0.14664E−04
Seventh Surface
K = −0.50000E+02, A4 = −0.27988E−02, A6 = −0.45948E−02,
A8 = −0.56979E−03, A10 = 0.17000E−03, A12 = −0.37084E−04,
A14 = 0.41323E−05
Eighth Surface
K = −0.49386E+33, A4 = 0.18639E−01, A6 = −0.89663E−02,
A8 = 0.17363E−02, A10 = −0.89531E−04, A12 = −0.96168E−04,
A14 = 0.13137E−04
Ninth Surface
K = −0.84988E+01, A4 = −0.30876E−01, A6 = 0.10197E−01,
A8 = −0.17973E−02, A10 = 0.33915E−03, A12 = −0.53647E−04,
A14 = 0.30241E−05
Tenth Surface
K = −0.17873E+00, A4 = −0.12155E+00, A6 = 0.17609E−01,
A8 = −0.16290E−03, A10 = −0.23183E−03, A12 = 0.25129E−04,
A14 = −0.96725E−06
Eleventh Surface
K = −0.38095E+01, A4 = −0.45467E−01, A6 = 0.88377E−02,
A8 = −0.11539E−02, A10 = 0.86568E−04, A12 = −0.33484E−05,
A14 = 0.49616E−07

Single lens data of the image pickup lens of Example 2 is shown below.

| Lens | Start Surface | Focal Length (mm) |
|---|---|---|
| 1 | 2 | 4.670 |
| 2 | 4 | −7.054 |
| 3 | 6 | 18.255 |
| 4 | 8 | 4.071 |
| 5 | 10 | −3.656 |

Variable distances A and B in the surface data of the image pickup lens of Example 2 are as follows:

| Object Distance | Variable Distance A | Variable Distance B |
|---|---|---|
| Infinite | 0.864 | 0.426 |
| 100 mm | 0.708 | 0.582 |

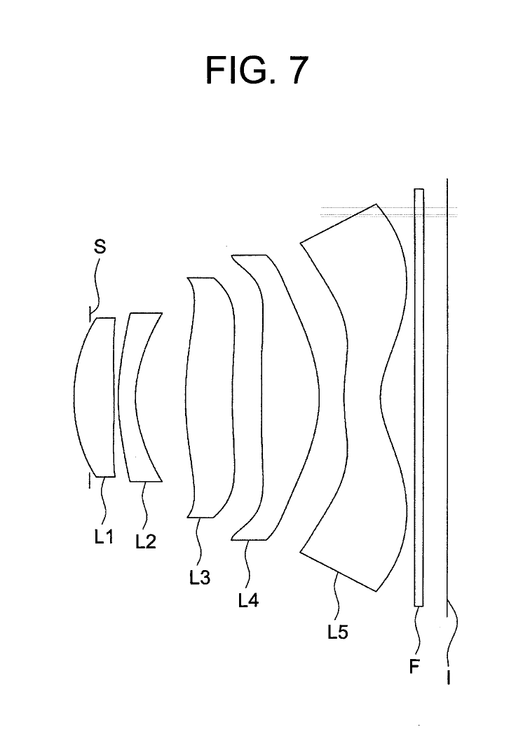

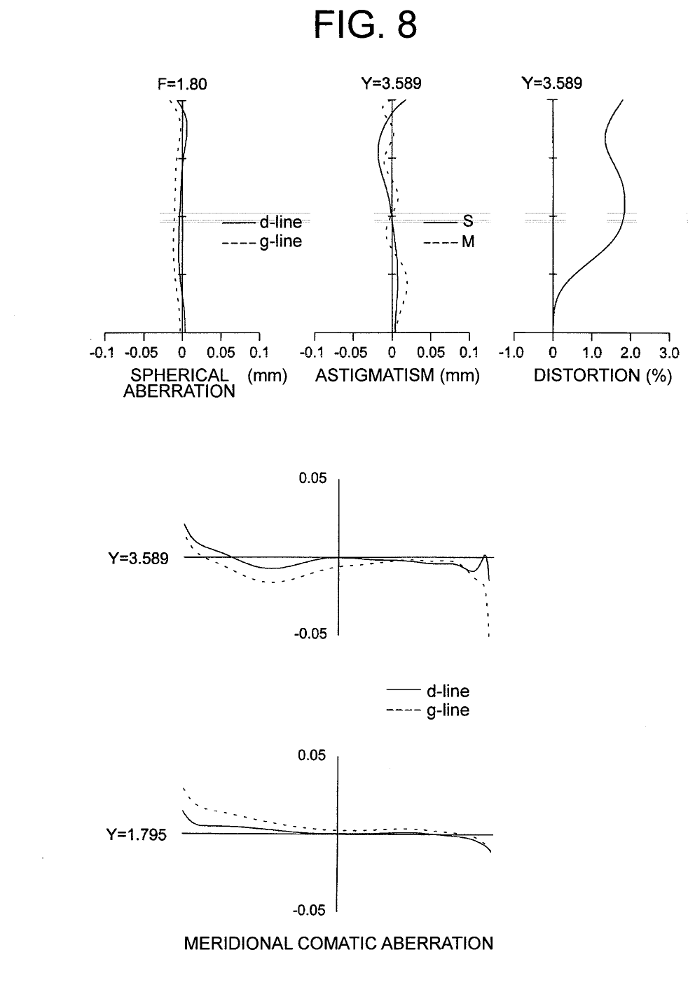

FIG. 7 is a cross-sectional diagram of an image pickup lens of Example 2. In this figure, L1 is the first lens, L2 is the second lens, L3 is the third lens, L4 is the fourth lens, L5 is the fifth lens, S is the aperture stop, and I is the imaging plane. Moreover, F is the parallel plate element which may be an optical low-pass filter, an IR cut filter, seal glass of a solid-state image sensor, or the like. FIG. 8 is an aberration chart of an image pickup lens of Example 2 (spherical aberration, astigmatism, distortion, and meridional comatic aberration).

In this Example, all of lenses are formed from plastic material. The first lens, second lens and fifth lens are fixed to the imaging plane, and the third lens and fourth lens are moved in a body in the optical axis direction, thereby performing focusing operation.

### Example 3

A total specification of an image pickup lens of Example 3 is as follows.

f=4.66 mm

fB=0.56 mm

F=2.00

2Y=7.195 mm

ENTP=0.00 mm

EXTP=−4.01 mm

H1=−0.09 mm

H2=−4.10 mm Surface data of the image pickup lens of Example 3 is shown below.

| | | | | | Effective Radius |
|---|---|---|---|---|---|
| Surface No. | R (mm) | D (mm) | Nd | νd | (mm) |
| 1 (Stop) | ∞ | −0.075 | | | 1.16 |
| 2* | 3.802 | 0.728 | 1.54470 | 56.2 | 1.19 |
| 3* | −8.774 | 0.053 | | | 1.34 |
| 4* | 2.762 | 0.300 | 1.63200 | 23.4 | 1.48 |
| 5* | 1.728 | 0.864 | | | 1.54 |
| 6* | 8.217 | 0.972 | 1.54470 | 56.2 | 2.03 |
| 7* | 7.797 | 0.365 | | | 2.15 |
| 8* | −360.135 | 0.986 | 1.54470 | 56.2 | 2.18 |
| 9* | −1.383 | 0.170 | | | 2.36 |
| 10* | 4.109 | 0.664 | 1.58300 | 30.0 | 2.78 |
| 11* | 1.080 | 0.900 | | | 3.43 |
| 12 | ∞ | 0.145 | 1.51630 | 64.1 | 3.67 |
| 13 | ∞ | | | | 3.70 |

Aspherical coefficients are as follows:

Second Surface
K = −0.14149E+01, A4 = −0.16780E−02, A6 = −0.77137E−02,
A8 = 0.33364E−04, A10 = −0.57218E−04, A12 = −0.43315E−03,
A14 = −0.20648E−04
Third Surface
K = 0.28905E+02, A4 = 0.58840E−02, A6 = −0.11764E−01,
A8 = 0.56977E−03, A10 = 0.16066E−02, A12 = −0.15313E−02,
A14 = 0.39621E−03
Fourth Surface
K = −0.33423E+01, A4 = −0.44461E−01, A6 = 0.19791E−01,
A8 = −0.84606E−02, A10 = 0.93676E−03, A12 = 0.37161E−03,
A14 = −0.36208E−04
Fifth Surface
K = −0.40345E+01, A4 = −0.58718E−03, A6 = 0.10481E−01,
A8 = −0.70973E−02, A10 = 0.23289E−02, A12 = −0.44264E−03,
A14 = 0.53381E−04
Sixth Surface
K = −0.14092E+02, A4 = −0.15572E−01, A6 = 0.77596E−03,
A8 = 0.12054E−02, A10 = −0.34397E−03, A12 = 0.57233E−04,
A14 = −0.38234E−05
Seventh Surface
K = −0.49640E+02, A4 = −0.11488E−01, A6 = −0.34732E−02,
A8 = −0.57457E−03, A10 = 0.55627E−04, A12 = −0.98692E−05,
A14 = 0.48566E−05
Eighth Surface
K = −0.18698E+40, A4 = 0.13715E−01, A6 = −0.78470E−02,
A8 = 0.92167E−03, A10 = −0.12698E−03, A12 = −0.51355E−04,
A14 = 0.95621E−05
Ninth Face
K = −0.46615E+01, A4 = −0.22055E−01, A6 = 0.63991E−02,
A8 = −0.10531E−02, A10 = 0.14246E−03, A12 = −0.20723E−04,
A14 = 0.20035E−05
Tenth Surface
K = 0.84591E+00, A4 = −0.71240E−01, A6 = 0.78213E−02,
A8 = −0.91251E−04, A10 = −0.86632E−04, A12 = 0.11456E−04,
A14 = −0.56108E−06
Eleventh Surface
K = −0.42097E+01, A4 = −0.31106E−01, A6 = 0.56680E−02,
A8 = −0.69799E−03, A10 = 0.47251E−04, A12 = −0.14953E−05,
A14 = 0.13416E−07

Single lens data of the image pickup lens of Example 3 is shown below.

| Lens | Start Surface | Focal Length (mm) |
|---|---|---|
| 1 | 2 | 4.971 |
| 2 | 4 | −8.224 |
| 3 | 6 | −1525.592 |
| 4 | 8 | 2.547 |
| 5 | 10 | 2.733 |

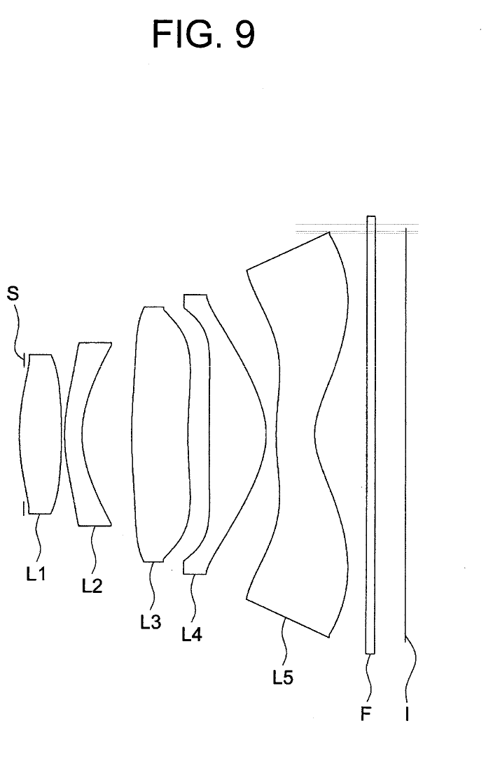

FIG. 9 is a cross-sectional diagram of an image pickup lens of Example 3. In this figure, L1 is the first lens, L2

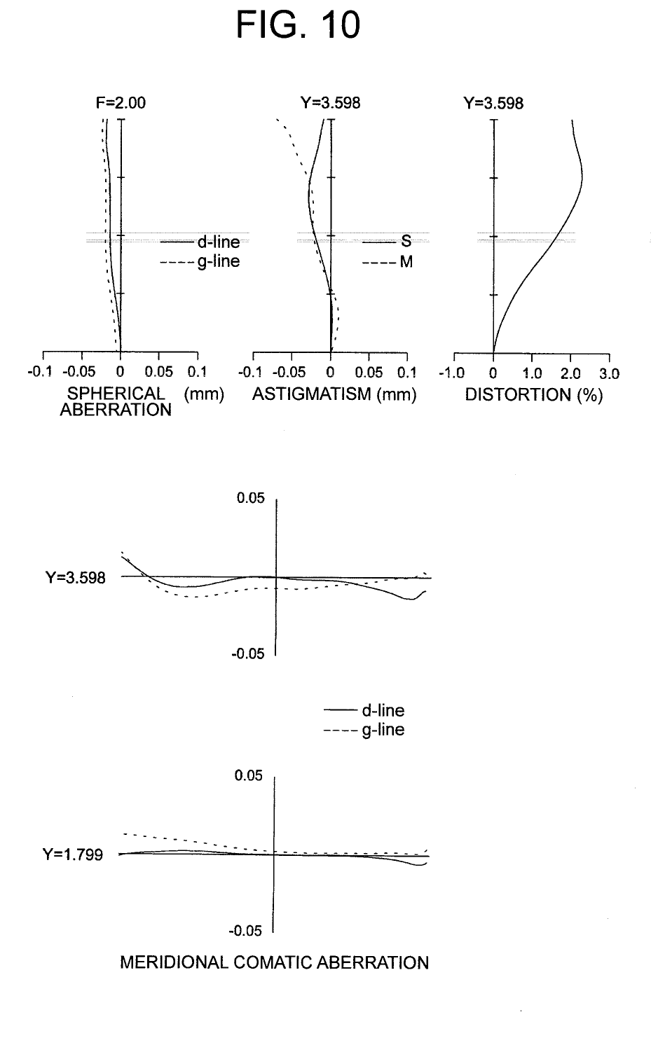

Is the second lens, L3 is the third lens, L4 is the fourth lens, L5 is the fifth lens, S is the aperture stop, and I is the imaging plane. Moreover, F is the parallel plate element which may be an optical low-pass filter, an IR cut filter, seal glass of a solid-state image sensor, or the like. FIG. 10 is an aberration chart of an image pickup lens of Example 3 (spherical aberration, astigmatism, distortion, and meridional comatic aberration).

In this Example, all of lenses are formed from plastic material, and all of the lenses from the first lens to the fifth lens are moved in a body in the optical axis direction, thereby performing focusing operation.

### Example 4

A total specification of an image pickup lens of Example 4 is as follows:

f=4.71 mm

f B=0.32 mm

F=1.80

2Y=7.178 mm

ENTP=0.00 mm

EXTP=−3.54 mm

H1=−1.03 mm

H2=−4.38 mm

Surface data of the image pickup lens of Example 4 is shown below.

| | | | | | Effective Radius |
|---|---|---|---|---|---|
| Surface No. | R (mm) | D (mm) | Nd | νd | (mm) |
| 1 (Stop) | ∞ | −0.297 | | | 1.31 |
| 2* | 2.688 | 0.763 | 1.54470 | 56.2 | 1.37 |
| 3* | −19.848 | 0.050 | | | 1.39 |
| 4* | 3.362 | 0.300 | 1.63200 | 23.4 | 1.43 |
| 5* | 1.794 | Variable Distance A | | | 1.45 |
| 6* | 5.669 | 0.877 | 1.54470 | 56.2 | 1.91 |
| 7* | 7.148 | 0.337 | | | 2.13 |
| 8* | −88.212 | 0.952 | 1.54470 | 56.2 | 2.22 |
| 9* | −2.289 | Variable Distance B | | | 2.44 |
| 10* | 2.306 | 0.648 | 1.58300 | 30.0 | 2.71 |
| 11* | 1.137 | 0.800 | | | 3.36 |
| 12 | ∞ | 0.145 | 1.51630 | 64.1 | 3.62 |
| 13 | ∞ | | | | 3.64 |

Aspherical coefficients are as follows:

Second Surface
K = 0.39391E+00, A4 = 0.38550E−02, A6 = −0.34677E−02,
A8 = 0.30238E−02, A10 = 0.61290E−04, A12 = −0.90273E−03,
A14 = 0.30466E−03
Third Surface
K = −0.50000E+02, A4 = 0.20068E−01, A6 = −0.17289E−02,
A8 = −0.12697E−02, A10 = 0.30437E−02, A12 = −0.30632E−02,
A14 = 0.97977E−03
Fourth Surface
K = −0.34830E+01, A4 = −0.56805E−01, A6 = 0.35617E−01,
A8 = −0.12242E−01, A10 = −0.15176E−03, A12 = 0.13735E−03,
A14 = 0.26412E−03
Fifth Surface
K = −0.49200E+01, A4 = −0.24777E−02, A6 = 0.16680E−01,
A8 = −0.10566E−01, A10 = 0.50665E−02, A12 = −0.19379E−02,
A14 = 0.41049E−03
Sixth Surface
K = 0.62154E+00, A4 = −0.18720E−01, A6 = −0.45684E−03,
A8 = 0.18002E−02, A10 = −0.75058E−03, A12 = 0.11751E−03,
A14 = −0.78812E−05
Seventh Surface
K = −0.33946E+02, A4 = −0.22021E−02, A6 = −0.41599E−02,
A8 = −0.68904E−03, A10 = 0.93542E−04, A12 = −0.25093E−04,
A14 = 0.45733E−05
Eighth Surface
K = −0.49330E+33, A4 = 0.21214E−01, A6 = −0.77692E−02,
A8 = 0.10254E−02, A10 = −0.60308E−04, A12 = −0.82405E−04,
A14 = 0.11777E−04
Ninth Surface
K = −0.61638E+01, A4 = −0.31905E−01, A6 = 0.12209E−01,
A8 = −0.21631E−02, A10 = 0.30643E−03, A12 = −0.39915E−04,
A14 = 0.22289E−05
Tenth Surface
K = −0.74551E+00, A4 = −0.12887E+00, A6 = 0.17473E−01,
A8 = −0.13961E−03, A10 = −0.24006E−03, A12 = 0.28785E−04,
A14 = −0.11845E−05
Eleventh Surface
K = −0.30746E+01, A4 = −0.50278E−01, A6 = 0.96386E−02,
A8 = −0.12303E−02, A10 = 0.87566E−04, A12 = −0.29159E−05,
A14 = 0.26517E−07

Single lens data of the image pickup lens of Example 4 is shown below.

| Lens | Start Surface | Focal Distance (mm) |
|---|---|---|
| 1 | 2 | 4.399 |
| 2 | 4 | −6.577 |
| 3 | 6 | 41.607 |
| 4 | 8 | 4.297 |
| 5 | 10 | −4.836 |

Variable distances A and B in the surface data of the image pickup lens of Example 4 are as follows.

| Objection Distance | Variable Distance A | Variable Distance B |
|---|---|---|
| Infinite | 0.905 | 0.403 |
| 100 mm | 0.721 | 0.586 |

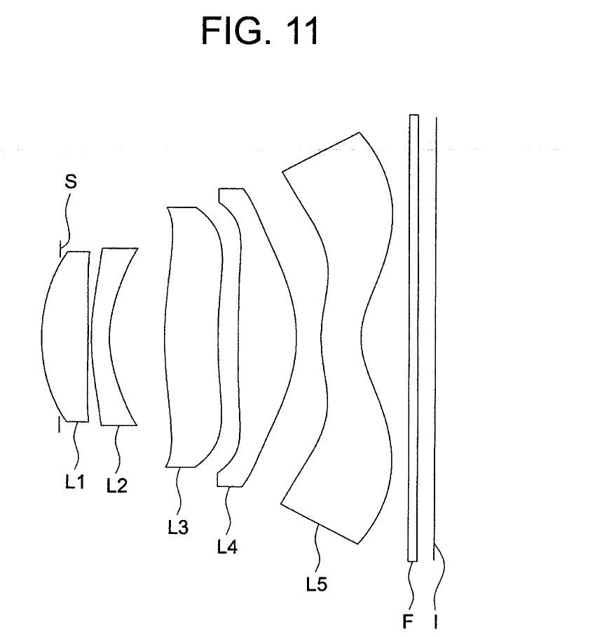

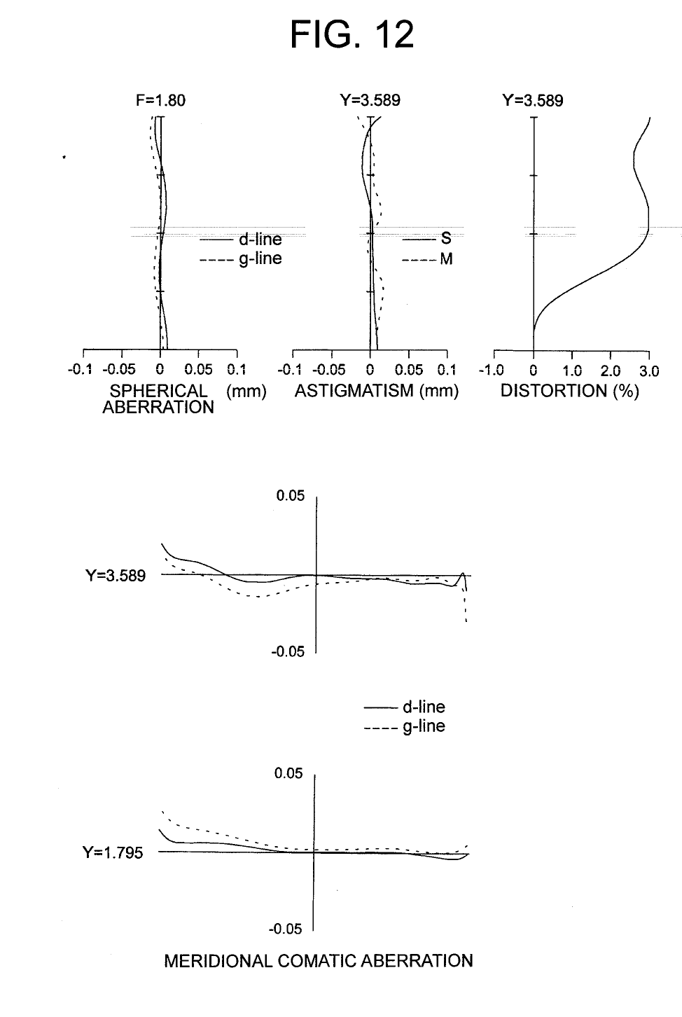

FIG. 11 is a cross-sectional diagram of an image pickup lens of Example 4. In this figure, L1 is the first lens, L2 is the second lens, L3 is the third lens, L4. is the fourth lens, L5 is the fifth lens, S is the aperture stop, and I is the imaging plate. Moreover, F is the parallel plate element which may be an optical low-pass filter, an IR cut filter, seal glass of a solid-state image sensor, or the like. FIG. 12 is an aberration chart of an image pickup lens of Example 4 (spherical aberration, astigmatism, distortion, and meridional comatic aberration).

In this Example, all of lenses are formed from plastic material. The first lens, second lens and fifth lens are fixed to the imaging plane, and the third lens and fourth lens are moved in a body in the optical axis direction, thereby performing focusing operation.

(Values in Each of Conditional Formulae)

Values corresponding to each of conditional formulae of Examples 1 to 4 are as follows:

| | Formula | Example 1 | Example 2 | Example 3 | Example 4 |
|---|---|---|---|---|---|
| (1): | f12/f | 2.65 | 2.10 | 2.09 | 1.99 |
| (2): | d5/f | 0.30 | 0.17 | 0.21 | 0.19 |
| (3): | f/\|f3\| | 0.286 | 0.258 | 0.003 | 0.113 |
| (4): | f34/f | 0.71 | 0.78 | 0.57 | 0.89 |
| (5): | ν5 | 30.0 | 30.0 | 30.0 | 30.0 |
| (6): | L/2Y | 1.18 | 1.10 | 1.14 | 1.11 |

Herein, since a plastic material largely changes in refractive index when its temperature changes, if all of the lenses from the first lens L1 to the fifth lens L5 are composed of plastic lenses, there is a problem in which an image point position in the entire image pickup lens system varies when ambient temperature changes.

Therefore, it has recently been found that the change in temperature of the plastic material can be reduced by mixing inorganic fine particles into the plastic material. Specifically, it has been generally difficult to use the plastic material as an optical material because if fine particles are mixed into a transparent plastic material, light rays are scattered, causing reduction in light transmittance. However, it is possible to substantially avoid the scattering of light by making the size of the fine particles smaller than the wavelength of a transmitted light beam. The refractive index of the plastics material falls as its temperature rises, whereas the refractive index of an inorganic particle rises as its temperature rises. Therefore, utilizing these temperature dependency properties in such a manner that they cancel each other allows the change in refractive index to hardly occur. Specifically, it is possible to obtain a plastic material having an extremely low temperature dependency property in refractive index by dispersing the inorganic particles having a maximum length of 20 mm or less into a parent plastic material. For example, it is possible to reduce the change in refractive index depending on temperature change by dispersing particles of oxide niobium (Nb₂O₅) into an acrylic material. In the present invention, the plastic material with such inorganic particles being dispersed is used for the positive lens (L1) having comparatively large refractive power, or all of the lenses (L1 to L5), which makes it possible to reduce the variation of the image point position when changing the temperature of the entire image pickup lens system.

Moreover, recently, as a method for massively mounting in low cost the image pickup apparatus, there has been proposed a technique for simultaneously mounting both electronic components of IC chips and others and optical devices on a board in such a way that a structure obtained by placing both the electronic components and the optical devices on the board with solder being potted in advance is subjected to a reflow process (a heating process) so as to melt the solder.

To mount components by using such a reflow process, it is necessary to heat the optical devices together with the electronic components at a temperature of about 200 to 260 degrees, but there is a problem in which a lens using thermoplastics resin is thermally deformed or discolored under such a high temperature, resulting in deterioration of optical performance. As one of methods for solving this problem, there is proposed a technique of using a glass mold lens having excellent heat-resistant performance to reconcile the miniaturization with the optical performance in a high temperature environment. However, there has been a problem in which it is impossible to meet the demand of reducing the cost of the image pickup apparatus because the cost of the glass mold lens is higher than that of the lens using thermoplastics resin.

In such a circumstance, the use of energy curable resin as material of the image pickup lens reduces the deterioration of optical performance upon exposure to a high temperature, as compared to the lens using thermosetting resin such as polycarbonate or polyolefin, therefore, the use of energy curable resin is effective for the reflow process and makes it easy to manufacture in low cost a lens as compared to the glass mold lens, thereby allowing the reconciliation between cost reduction and mass production of the image pickup apparatus with an image pickup lens being incorporated. Herein, the energy curable resin refers to both the thermosetting resin and ultraviolet curable resin.

The present invention's plastic lens may be formed by using the aforementioned energy curable resin.

In addition, in this Example, a principal ray incident angle of a light beam entering to the imaging plane of the solid-state image sensor is not necessarily designed in sufficiently small size at periphery of the imaging plane. However, a recent technique has made it possible to reduce a shading effect by reviewing the alignment of a chromatic filter or on-chip micro lens array of the solid-state image sensor. Specifically, if the pitch in alignment of the chromatic filter or on-chip micro lens array is set in a slightly smaller value with respect to the pixel pitch of the imaging plane of the image sensor, the chromatic filter or on on-chip micro lends array is shifted toward the optical axis side of the image pickup lens for each of pixels, as getting close to the periphery of the imaging plane, therefore, it is possible to efficiently lead an oblique incident light beam to a light reception unit of each pixel. This allows the shading effect generated in the solid-state image sensor to be reduced. This Example is to provide a design example aiming to make more compact as the aforementioned requirement is relieved.

The present invention is not limited to the embodiment and examples as described in the specification, and there are included another embodiment or modified examples, which are clear for one skilled in the art from the embodiment or technical idea as described in the specification.

### REFERENCE SIGNS LIST

L1 First lens
L2 Second lens
L3 Third lens
L4 Fourth lens
L5 Fifth lens
8 Solid-state image sensor
11 Printed board
12a, 12b Cover members
13 Adjustable diaphragm apparatus
22 First guide axis
23 Piezoelectric device
24 Second guide axis
25 Movement mirror frame
50 Image pickup apparatus
100 Mobile telephone
F Parallel plate element
I Imaging plane
K Adjustable diaphragm
S Aperture stop

1. An image pickup lens for forming an image of an object on a photoelectric converting portion of a solid-state image sensor, comprising: in order from an object side,
a first lens having positive refractive power and having a convex surface facing toward the object side;
a meniscus-shaped second lens having negative refractive power and having a convex surface facing toward the object side;
a third lens having positive or negative refractive power;
a fourth lens having positive refractive power and having a convex surface facing toward an image side; and
a fifth lens having negative refractive power and having a concave surface facing toward the image side,
wherein an image-side surface of the fifth lens has an aspherical shape and has an inflection point at position other than an intersection point with an optical axis, and
the image pickup lens satisfies the following conditional formula:
1.5<f12/f<3.0 (1)
where
f12: composite focal length of the first lens and the second lens; and
f: focal length of an entire image pickup lens system.

2. The image pickup lens as recited in claim 1, wherein the image pickup lens satisfies the following conditional formula:
0.15<d5/f<0.35 (2)
where
d5: thickness along the optical axis of the third lens; and
f: focal length of the entire image pickup lens system.

3. The image pickup lens as recited in claim 1, wherein the image pickup lens satisfies the following conditional formula:
0<f/|f3|<0.35 (3)
where
f: focal length of the entire image pickup lens system; and
f3: focal length of the third lens.

4. The image pickup lens as claimed in claim 1, wherein the image pickup lens satisfies the following conditional formula:
0.50<f34/f<0.95 (4)
where
f34: composite focal length of the third lens and the fourth lens; and
f: focal length of the entire image pickup lens system.

5. The image pickup lens as claimed in claim 1, wherein the fourth lens has a biconvex shape.

6. The image pickup lens as claim in claim 1, wherein the image pickup lens satisfies the following conditional formula:
15<ν5<50 (5)
where
ν5: Abbe number of the fifth lens.

7. The image pickup lens as claimed in claim 1, wherein an aperture stop is arranged at a position toward the image side from a position on the optical axis of an object-side surface of the first lens and toward the object side from an outermost periphery of the object-side surface of the first lens.

8. The image pickup lens as claim 1, wherein focusing operation is performed by fixing the first lens, the second lens and the fifth lens of the image pickup lens with respect to an imaging plane and moving the third lens and the fourth lens together in a direction of the optical axis.

9. The image pickup lens as claimed in claim 1, wherein all the third lens, the fourth lens and the fifth lens of the image pickup lens have an inflection point at positions other than the intersection point with the optical axis of at least one side surface.

10. The image pickup lens as claimed in claim 1, wherein all the first lens, the second lens, the third lens, the fourth lens, and the fifth lens are formed from a plastic material.

11. An image pickup apparatus comprising the image pickup lens as recited in claim 1, and a solid-state image sensor arranged on the image side of the image pickup lens.

12. The image pickup apparatus as claimed in claim 11, comprising an adjustable diaphragm between a position on the optical axis of the object-side surface of the first lens of the image pickup lens and a position of the intersection point with the optical axis of an outermost ray of a light beam which enters to the first lens and focuses at the highest position in an image height.

13. A portable terminal comprising the image pickup apparatus as recited in claim 11.
